(19) United States
(12) Patent Application Publication
(10) Pub. No.: US 2025/0015399 A1
(43) Pub. Date: Jan. 9, 2025

(54) STORAGE BATTERY, BATTERY MODULE, AND LAMINATE FILM

(71) Applicant: HONDA MOTOR CO., LTD., Tokyo (JP)

(72) Inventors: Takahiro Tamura, Wako-Shi (JP); Hidemasa Usui, Wako-Shi (JP)

(73) Assignee: HONDA MOTOR CO., LTD., Tokyo (JP)

(21) Appl. No.: 18/894,597

(22) Filed: Sep. 24, 2024

Related U.S. Application Data
(63) Continuation of application No. PCT/JP2023/002044, filed on Jan. 24, 2023.

(30) Foreign Application Priority Data
Mar. 31, 2022 (JP) 2022-060694

(51) Int. Cl. H01M 50/105; H01M 10/613; H01M 10/615; H01M 50/124; H01M 50/136; H01M 50/186; H01M 50/211; H01M 50/289

(52) U.S. Cl. CPC H01M 50/105; H01M 10/613; H01M 10/615; H01M 50/124; H01M 50/136; H01M 50/186; H01M 50/211; H01M 50/289

(57) ABSTRACT

A storage battery includes: a power generation element; and an exterior body configured to wrap the power generation element, the exterior body is formed by folding a member forming the exterior body in two at a folded portion, the exterior body includes a housing portion housing the power generation element, and a peripheral edge portion around the housing portion including the folded portion, and a first portion of the peripheral edge portion closer to the folded portion than a side surface of the housing portion adjacent to the folded portion is folded along the side surface.

### CROSS-REFERENCE TO RELATED APPLICATION(S)

This application claims priority to and the benefit of Japanese Patent Application No. 2022-060694 filed on Mar. 31, 2022, the entire disclosure of which is incorporated herein by reference.

### BACKGROUND OF THE INVENTION

### Field of the Invention

The present invention relates to a storage battery, a battery module, and a laminate film.

### Description of the Related Art

From the viewpoint of climate-related disasters, electrification of industrial machines has been promoted in order to reduce CO2, and research on storage batteries as energy sources for the industrial machines has been conducted also for use in vehicles and the like. In a battery module including such a storage battery, since the performance, life, or the like of the storage battery may be affected by a temperature, a structure for adjusting the temperature of the storage battery may be provided. As an example of the structure for adjusting the temperature, Japanese Patent Laid-Open No. 2015-225765 describes a cooling structure including a storage battery and a heat conductive material integrally in contact with a cooling plate.

In the cooling and heating of the storage battery described above, it is desirable to efficiently transfer the heat of the storage battery. However, when the heat conductive material is provided between the storage battery and the cooling structure as in the above conventional technology, cooling and heating efficiency may be decreased depending on a contact state between the storage battery and the heat conductive material.

### SUMMARY OF THE INVENTION

An embodiment of the present invention provides technology for suppressing a decrease in cooling and heating efficiency of a storage battery.

According to one embodiment of the present invention, a storage battery includes: a power generation element; and an exterior body configured to wrap the power generation element, the exterior body is formed by folding a member forming the exterior body in two at a folded portion, the exterior body includes a housing portion housing the power generation element, and a peripheral edge portion around the housing portion including the folded portion, and a first portion of the peripheral edge portion closer to the folded portion than a side surface of the housing portion adjacent to the folded portion is folded along the side surface.

According to one embodiment of the present invention, a laminate film forms an exterior body by wrapping a power generation element, the exterior body is formed by folding the laminate film in two at a folded portion, the exterior body includes a housing portion housing the power generation element, and a peripheral edge portion around the housing portion, the laminate film includes a first recess portion provided on one side with respect to the folded portion and forming the housing portion, and a second recess portion provided at a position corresponding to the first recess portion on the other side opposite to the one side with respect to the folded portion and forming the housing portion, and a distance between the first recess portion and the second recess portion is equal to or more than a sum of depths of the first recess portion and the second recess portion.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a cross-sectional view schematically illustrating a battery module according to an embodiment;

FIG. 2A is a front view of an all-solid-state battery according to the embodiment;

FIG. 2B is a cross-sectional view taken along the line A-A of FIG. 2A;

FIG. 3A is a plan view illustrating a configuration of a laminate film;

FIG. 3B is a diagram taken in a direction of an arrow C in FIG. 3A;

FIG. 4 is a cross-sectional view taken along the line B-B of FIG. 2A, and illustrates a structure of a lower portion of the all-solid-state battery;

FIG. 5 is a front view of the all-solid-state battery, and illustrates a state before a lower portion of an exterior body is folded;

FIG. 6A is a diagram illustrating a modification of the exterior body;

FIG. 6B is a diagram illustrating a modification of the exterior body;

FIG. 6C is a diagram illustrating a modification of the exterior body; and

FIG. 7 is a diagram illustrating a modification of the structure of the lower portion of the all-solid-state battery.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

### <Battery Module BM>

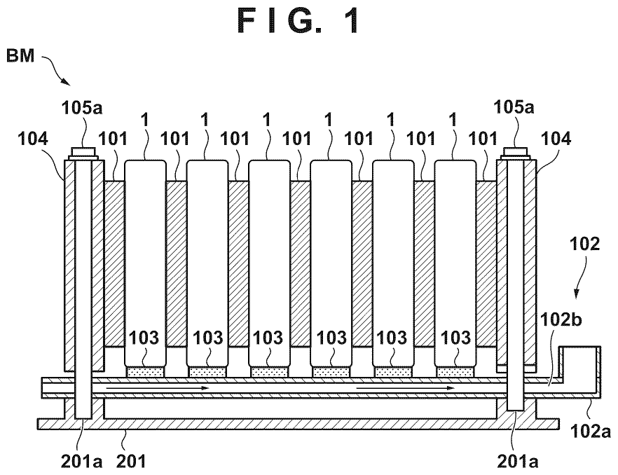

FIG. 1 is a cross-sectional view schematically illustrating a battery module BM according to an embodiment. The battery module BM is mounted on, for example, an electromotive vehicle such as a hybrid vehicle or an electric vehicle (EV) (not illustrated). The battery module BM includes a plurality of all-solid-state batteries 1, a plurality of separators 101, a cooling/heating unit 102, and a plurality of heat transfer members 103.

The plurality of all-solid-state batteries 1 (battery cells) are stacked in a thickness direction (Z direction) to constitute a battery group. The all-solid-state batteries 1 are alternately stacked in the Z direction with the separators 101 having insulating properties while being arranged in a standing posture. The configuration of the all-solid-state battery 1 will be described later.

The cooling/heating unit 102 cools or heats the all-solid-state battery 1. In the present embodiment, the cooling/heating unit 102 is a water-cooled heat sink in which a refrigerant passes through a fluid passage 102b formed in a plate-shaped member 102a. That is, the cooling/heating unit 102 has a structure for cooling the all-solid-state battery 1. However, the cooling/heating unit 102 may have a structure for heating the all-solid-state battery 1. Alternatively, the cooling/heating unit 102 may have both a cooling structure and a heating structure of the all-solid-state battery 1. Examples of the heating structure include a structure in which an electric heating wire is disposed on the plate-shaped member 102a. As the cooling structure, the cooling/heating unit 102 may adopt, for example, an air-cooling type cooling/heating structure that introduces traveling wind during traveling of the vehicle, or other known technologies can be appropriately used.

The heat transfer member 103 transfers the heat of the all-solid-state battery 1 to the cooling/heating unit 102. The heat transfer member 103 is disposed between the all-solid-state battery 1 and the cooling/heating unit 102. As the heat transfer member 103, a thermal conductive gel such as a silicone gel may be used. For example, a urethane-based, epoxy-based, modified silane-based, or acryl-based heat dissipation adhesive may be used as the heat transfer member 103. In addition, for example, as the heat transfer member 103, a putty sheet made of silicone for heat dissipation which is clayey and closely adheres to irregularities, grease made of silicone for heat dissipation, or the like may be used. In the present embodiment, the plurality of heat transfer members 103 are provided corresponding to the plurality of all-solid-state batteries 1, but the heat transfer members 103 may be provided across the plurality of all-solid-state batteries 1.

End plates 104 having a substantially flat plate shape are disposed at both ends in a stacking direction of a stacked product of the all-solid-state battery 1 and the separator 101. A hole through which a fastening bolt 105a for fixing the battery module BM to an installation site 201 can penetrate is formed in the end plate 104. The installation site 201 is formed with, for example, a pair of female screw portions 201a which is formed of a sheet metal of an electromotive vehicle and into which a pair of fastening bolts 105a is screwed.

### <All-Solid-State Battery>

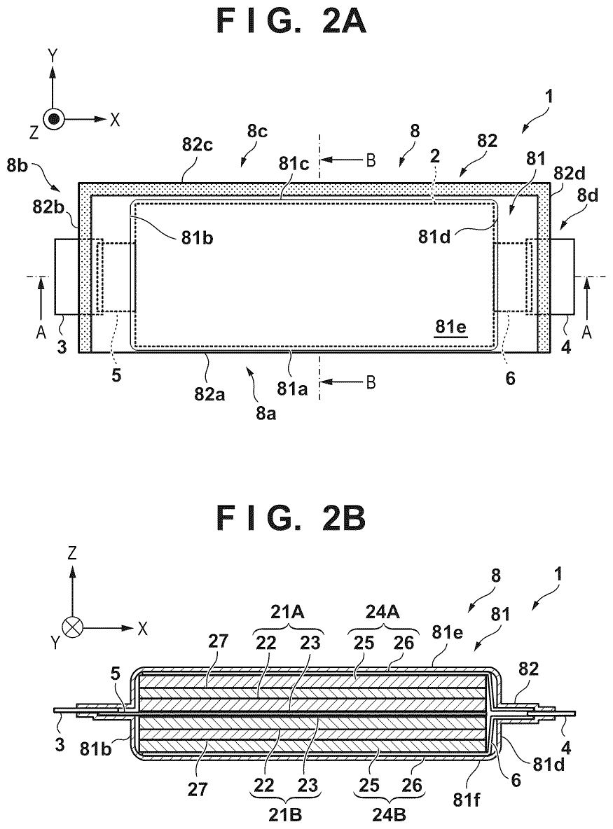

FIG. 2A is a front view of the all-solid-state battery 1 according to the embodiment of the present invention, and FIG. 2B is a cross-sectional view taken along the line A-A of FIG. 2A. In the drawings, an arrow X indicates a longitudinal direction of the all-solid-state battery 1 (or an extending direction of a lead tab), an arrow Y indicates a width direction of the all-solid-state battery 1 (or a direction orthogonal to the extending direction of the lead tab), and an arrow Z indicates a thickness direction of the all-solid-state battery 1 (a stacking direction of a laminate 2), and an X direction, a Y direction, and a Z direction are orthogonal to each other. FIG. 2A is a diagram of the all-solid-state battery 1 as viewed in the Z direction.

The all-solid-state battery 1 includes a laminate 2 which is a storage element, lead tabs 3 and 4, current collecting tabs 5 and 6, and an exterior body 8 wrapping the laminate 2, and has a form of a battery cell suitable for an assembled battery.

The laminate 2 has a rectangular parallelepiped shape as a whole, and includes two positive electrode layers 21A and 21B and two negative electrode layers 24A and 24B to have a structure in which each of the number of positive electrode layers and the number of negative electrode layers is two. However, in the laminate 2, each of the number of positive electrode layers and the number of negative electrode layers may be one or three or more. Solid electrolyte layers 27 are respectively provided between the positive electrode layer 21A and the negative electrode layer 24A and between the positive electrode layer 21B and the negative electrode layer 24B.

Each of the positive electrode layers 21A and 21B includes a positive electrode active material layer 22, and a positive electrode current collector 23 is shared between the two positive electrode layers 21A and 21B. The positive electrode current collector 23 is arranged in the form of a layer at the center of the laminate 2 in the Z direction, and the respective positive electrode active material layers 22 are stacked on the front and back sides thereof.

The negative electrode layers 24A and 24B are arranged on one outer side and the other outer side in the Z direction with respect to the positive electrode layers 21A and 21B, respectively, and are stacked such that the negative electrode layers 24A and 24B sandwich the positive electrode layers 21A and 21B. However, contrary to the configuration in the present embodiment, it is also possible to adopt a configuration in which those layers are stacked such that the two positive electrode layers sandwich the two negative electrode layers. The negative electrode layers 24A and 24B each include a negative electrode active material layer 25 and a negative electrode current collector 26. The two negative electrode current collectors 26 are formed in the form of layers on the outermost layers of the laminate 2, respectively.

Examples of the active material constituting the positive electrode active material layer 22 include lithium cobalt oxide, lithium nickel oxide, lithium manganese oxide, lithium metal phosphate, lithium nickel cobalt manganese oxide, and lithium nickel cobalt aluminate. Examples of an active material constituting the negative electrode active material layer 25 include a lithium-based material and a silicon-based material. Examples of the lithium-based material include Li metal and Li alloy. Examples of the silicon-based material include Si and SiO. Other examples of the active material constituting the negative electrode active material layer 25 include carbon materials such as graphite, soft carbon, and hard carbon, tin-based materials (Sn, SnO, and the like), and lithium titanate.

The solid electrolyte layer 27 is made of, for example, a solid electrolyte having ion conductivity. As its material, a sulfide-based solid electrolyte material, an oxide-based solid electrolyte material, a nitride-based solid electrolyte material, and halide-based solid electrolyte material, and the like can be mentioned. The positive electrode current collector 23 and the negative electrode current collector 26 are made of, for example, a metal foil such as aluminum, copper, or SUS, a metal sheet, or a metal plate. The positive electrode active material layer 22, the negative electrode active material layer 25, and the solid electrolyte layer 27 may be formed by bonding particles of substances that constitute them with an organic polymer compound-based binder.

The lead tabs 3 and 4 are connected to a charger or an electric load to charge or discharge the laminate 2. One end portions of the lead tabs 3 and 4 are located outside the exterior body 8, and the other end portions thereof are located inside the exterior body 8. Here, the inside of the exterior body 8 refers to a space formed by a housing portion 81 of the exterior body 8 to be described later.

The other end portion of the lead tab 3 is connected to the positive electrode current collector 23 via the current collecting tab 5 inside the exterior body 8, and the lead tab 3 forms a positive electrode tab. The lead tab 3 and the current collecting tab 5 are formed of, for example, a conductive metal sheet or metal plate. On the other hand, the other end portion of the lead tab 4 is connected to the negative electrode current collector 26 via the current collecting tab 6 inside the exterior body 8, and the lead tab 4 forms a negative electrode tab. The lead tab 4 and the current collecting tab 6 are formed of, for example, a conductive metal sheet or metal plate.

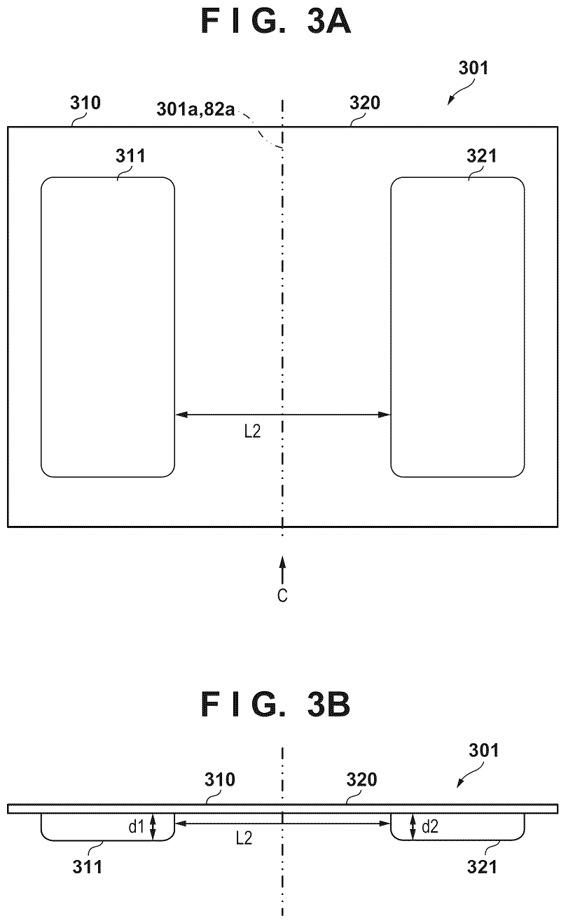

The exterior body 8 wraps the laminate 2. In the present embodiment, the exterior body 8 is formed by folding a laminate film 301 forming the exterior body 8 in two. Here, FIG. 3A is a plan view illustrating the configuration of the laminate film 301, and FIG. 3B is a diagram taken along an arrow C in FIG. 3A. The laminate film 301 is formed by, for example, covering front and back surfaces of a metal layer with a resin layer (insulating layer). The exterior body 8 formed of the laminate film 301 has flexibility capable of following expansion and contraction of the laminate 2. The flexibility capable of following the expansion and contraction of the laminate 2 can be obtained by the way of wrapping the laminate 2, the shape and structure of the exterior body 8, and the like.

In the present embodiment, the exterior body 8 has a rectangular shape having four sides 8a to 8d when viewed in the Z direction. When viewed in the Z direction, the exterior body 8 includes the housing portion 81 that houses the laminate 2, and a peripheral edge portion 82 around the housing portion 81. Here, the housing portion 81 is disposed at a center portion of the exterior body 8 when viewed in the Z direction, but may be disposed biased to the left and right and/or up and down.

The housing portion 81 is formed by overlapping recess portions 311 and 321 respectively formed in portions 310 and 320 on both sides of the folded portion 301a in a state where the laminate film 301 is opened when the laminate film 301 is folded. The housing portion 81 includes principal surfaces 81e and 81f that extend in a plane (XY plane) intersecting the stacking direction (Z direction) of the laminate 2 and face each other, and side surfaces 81a to 81d disposed so as to connect the principal surfaces 81e and 81f.

The peripheral edge portion 82 is formed by overlapping portions where the recess portions 311 and 321 are not formed in a state where the laminate film 301 is opened. In the case of the present embodiment, the side 8a among the four sides on the outer side of the peripheral edge portion 82 includes a folded portion 82a that is folded when the laminate film 301 is folded in two. As will be described in detail later, in the present embodiment, a portion of the peripheral edge portion 82 between the folded portion 82a and the side surface 81a is folded along the side surface 81a.

The other three sides 8b to 8d include sealing portions 82b to 82d, respectively. The sealing portions 82b to 82d are formed by bonding a material of the exterior body 8 (laminate film 301) by adhesion, welding or the like. On the sides 8b and 8d facing each other among the three sides 8b to 8d, the lead tabs 3 and 4 are provided so as to cross the sealing portions 82b and 82d, respectively.

### <Folding Structure of Exterior Body>

As illustrated in FIG. 1, when the all-solid-state battery 1 is used for the battery module BM, the all-solid-state battery 1 is disposed such that a predetermined surface of the all-solid-state battery 1 is in contact with the heat transfer member 103. In the present embodiment, in order to efficiently release the heat of the all-solid-state battery 1 from the heat transfer member 103, a folding structure of the exterior body 8 described below is adopted.

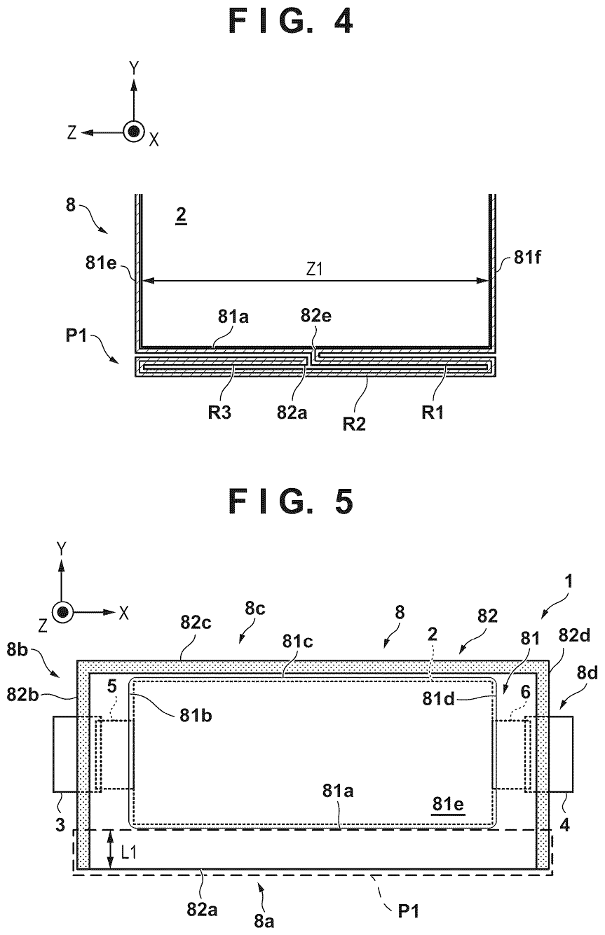

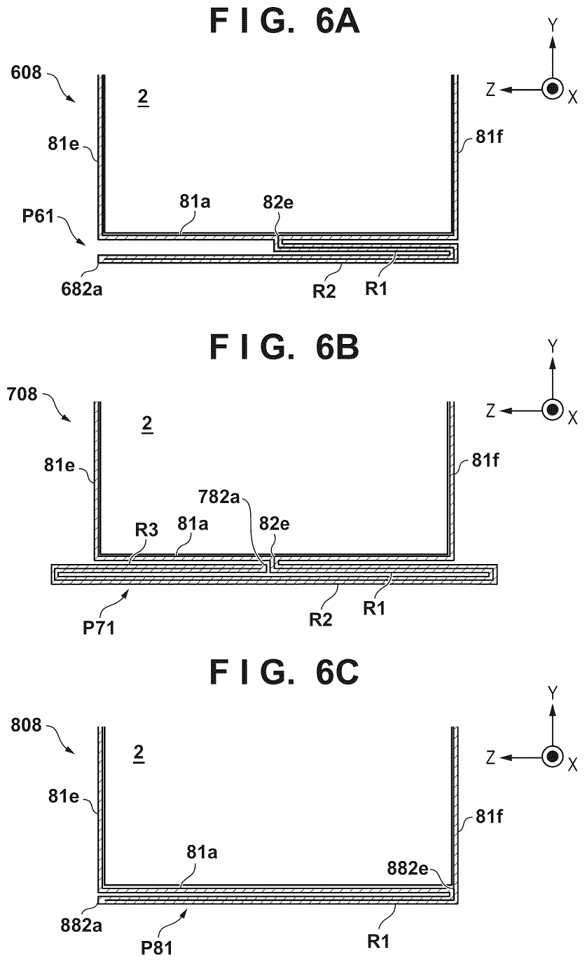

FIG. 4 is a cross-sectional view taken along the line B-B in FIG. 2A, and illustrates a structure of a lower portion of the all-solid-state battery 1. FIG. 5 is a front view of the all-solid-state battery 1, and illustrates a state before the lower portion of the exterior body 8 is folded. In FIG. 4 (and FIGS. 6A to 6C to be described later), there are portions in which the thickness, the interval, and the like of the members are emphasized in order to facilitate understanding of the structure.

In the present embodiment, a portion P1 of the peripheral edge portion 82 closer to the folded portion 82a than the side surface 81a of the housing portion 81 adjacent to the folded portion 82a is folded along the side surface 81a. The portion P1 closer to the folded portion 82a is a portion surrounded by the folded portion 82a, portions of the sealing portions 82b and 82d closer to the folded portion 82a than the side surface 81a in the Y direction, and the connection portion 82e between the side surface 81a and the peripheral edge portion 82 in a state before the portion P1 is folded. In other words, the portion P1 closer to the folded portion 82a is a portion closer to the folded portion 82a than the connection portion 82e when viewed along the extending direction of the laminate film 301 forming the exterior body 8. As a result, the peripheral edge portion 82 extends from the side surfaces 81b to 81d of among the side surfaces of the housing portion 81 in a substantially normal direction of the surface, whereas the peripheral edge portion 82 extends along a direction horizontal to the surface for the side surface 81a. Therefore, the lower surface of the exterior body 8 in the illustrated direction is flat.

That is, in the present embodiment, when the all-solid-state battery 1 is used in the battery module BM illustrated in FIG. 1, a contact surface of the all-solid-state battery 1 with the heat transfer member 103 (here, a surface formed by the side surface 81a) is flat. As a result, the heat transfer member 103 can be made thinner as compared with a case where the contact surface has irregularities, and the heat transfer property of the heat transfer member 103 can be improved (the heat resistance of the heat transfer member 103 can be reduced). Therefore, since the heat of the all-solid-state battery 1 can be efficiently transferred to a cooling/heating element, it is possible to suppress a decrease in cooling and heating efficiency of the all-solid-state battery 1.

In addition, in the present embodiment, the portion P1 closer to the folded portion 82a includes a region R1 extending from the connection portion 82e with the housing portion 81 to one side (positive side) in the stacking direction (Z direction) of the laminate 2, and a region R2 extending from an end portion on the positive side in the Z direction of the region R1 to the other side (negative side in the Z direction) opposite thereto. As described above, the portion P1 closer than the folded portion 82a is folded to form the plurality of regions R1 and R2, so that irregularities of the contact surface between the all-solid-state battery 1 and the heat transfer member 103 are easily reduced. As a result, a gap or the like is less likely to occur between the all-solid-state battery 1 and the heat transfer member 103, and the all-solid-state battery 1 and the heat transfer member 103 are more likely to be in close contact with each other, so that the heat of the all-solid-state battery 1 can be efficiently transmitted to the cooling/heating element. Therefore, it is possible to suppress a decrease in cooling or heating efficiency of the all-solid-state battery 1.

In the present embodiment, the region R2 extends from an end portion on one side (positive side) to an end portion on the other side (negative side in the Z direction) in the stacking direction (Z direction) of the laminate 2. Therefore, since the region R2 is provided to extend over substantially the entire area in the stacking direction below the laminate 2, the contact surface with the heat transfer member 103 in the all-solid-state battery 1 can be configured by the region R2. Therefore, the irregularities of the contact surface between the all-solid-state battery 1 and the heat transfer member 103 can be further reduced.

In the present embodiment, the portion P1 closer to the folded portion 82a includes a region R3 extending from the end portion on the negative side in the Z direction of the region R2 to the folded portion 82a on the positive side in the Z direction. As a result, the height of the portion P1 closer to the folded portion 82a is stabilized, and the irregularities of the contact surface between the all-solid-state battery 1 and the heat transfer member 103 can be further reduced.

In the present embodiment, the regions R1 and R3 are located closer to the laminate 2 than the region R2. That is, the region R2 is a region where the portion P1 is folded downward (the side far from the laminate 2) at the end portion on the positive side in the Z direction of the region R1. In addition, the region R3 is a region where the portion P1 is folded upward (toward the laminate 2) at the end portion on the negative side in the Z direction of the region R2. As a result, the portion P1 closer to the folded portion 82a and the heat transfer member 103 come into contact with each other only in the region R2, so that a step or the like is hardly formed on the contact surface. Therefore, the irregularities of the contact surface between the all-solid-state battery 1 and the heat transfer member 103 can be further reduced.

In addition, a length L1 (see FIG. 5) from the side surface 81a to the folded portion 82a is substantially twice a length Z1 (see FIG. 4) in the stacking direction of the laminate 2. In other words, the length L1 is substantially twice the length Z1 of the housing portion 81 in the stacking direction. As a result, the total length of the regions R1 and R3 and the length of the region R2 become substantially the same in the stacking direction (Z direction) of the laminate 2. Therefore, since the thickness in the Y direction of the portion P1 closer to the folded portion 82a is made uniform over the entire laminate 2 in the stacking direction (Z direction), the irregularities of the contact surface between the all-solid-state battery 1 and the heat transfer member 103 can be further reduced. Here, substantially twice may indicate, for example, 1.95 to 2.05 times, 1.9 to 2.1 times, 1.8 to 2.2 times, 1.7 to 2.3 times, or the like. That is, a relation between the total length of the regions R1 and R3 and the length of the region R2 may be any relation as long as the irregularities of the contact surface between the all-solid-state battery 1 and the heat transfer member 103 can be easily reduced.

As described in <Modifications>, the length L1 may be equal to or more than the length from the connection portion 82e to any end portion of the housing portion 81 in the Z direction. As a result, the portion P1 closer to the folded portion 82a can be extended to at least the end portion of the housing portion 81 in the Z direction, so that it is possible to suppress the occurrence of a step due to a break at a position where the portion P1 closer to the folded portion 82a overlaps the side surface 81a in the Z direction.

Next, the structure of the laminate film 301 as a member forming the exterior body 8 will be described with reference to FIGS. 3A and 3B again. The laminate film 301 has a sheet-like shape as a whole, and as described above, the recess portions 311 and 321 are formed on both sides of the folded portion 301a (corresponding to the folded portion 82a of the exterior body 8), respectively.

The recess portion 311 is a depression having a depth d1 with respect to the portion 310. The recess portion 321 is a depression having a depth d2 with respect to the portion 320. Here, the depth d1=the depth d2 is satisfied, but the depths of the recess portions 311 and 321 may be different. In addition, the recess portion 311 and the recess portion 321 are separated by the distance L2 in a direction intersecting the extending direction of the folded portion 301a.

In the present embodiment, the recess portions 311 and 321 are disposed such that the distance L2 is equal to or more than the sum of the depth d1 and the depth d2. Since the length of the portion P1 closer to the folded portion 82a can be secured to be relatively large, the portion P1 is easily folded along the folded portion 82a. When the distance L2 is equal to or larger than the sum of the depth d1 and the depth d2, the portion P1 closer to the folded portion 82a can extend from the connection portion 82e to the end portion on the positive side or the negative side in the Z direction of the housing portion 81 in the Z direction. Therefore, when the exterior body 8 is formed of the laminate film 301, the irregularities of the contact surface between the all-solid-state battery 1 and the heat transfer member 103 can be reduced.

Further, in the present embodiment, the recess portions 311 and 321 are disposed such that the distance L2 is substantially 4 times the sum of the depth d1 and the depth d2. Accordingly, when the exterior body 8 is formed of the laminate film 301, the portion P1 closer to the folded portion 82a can be folded to form the regions R1 to R3.

Here, as a comparative example with the present embodiment, first, a case where all of the four sides 8a to 8d of the exterior body 8 are sealed (four-side sealing) will be considered. In this case, the laminate film 301 is also sealed by adhesion, welding, or the like on the side 8a constituting the contact surface between the exterior body 8 and the heat transfer member 103. However, since the sealed portion is harder than the other portions, it may be difficult to fold the portion P1 closer to the folded portion 82a along the side surface 81a. Therefore, in the case of four-side sealing, the contact surface with the heat transfer member 103 may not be flattened as compared with the all-solid-state battery 1 of the present embodiment.

Next, as a comparative example with the present embodiment, a case where the distance L2 between the recess portion 311 and the recess portion 321 is short (insufficient) will be considered. For example, when the distance L2 is secured only to an extent necessary for folding the laminate film 301, the portion P1 closer to the folded portion 82a is not formed or is formed only to an insufficient extent for folding. However, the sealing portions of the sides 8b and 8d may extend below the side surface 81a, and as a result, the irregularities of the contact surface between the all-solid-state battery 1 and the heat transfer member 103 may become large.

In contrast to these comparative examples, in the present embodiment, since the contact surface of the all-solid-state battery 1 with the heat transfer member 103 can be relatively flattened, the contact surface between the all-solid-state battery 1 and the heat transfer member 103 can be made larger, and the heat of the all-solid-state battery 1 can be more efficiently transferred to the cooling/heating element.

In addition, when the portion of the all-solid-state battery 1 in contact with the heat transfer member 103 has irregularities, it is necessary to cause the heat transfer member 103 to be thick in the Y direction in order to absorb the irregularities. In the present embodiment, since the irregularities of the contact surface of the all-solid-state battery 1 with the heat transfer member 103 are suppressed, the heat transfer member 103 can be thinned in the Y direction as compared with the above-described comparative example. In addition, since the laminate 2 can be made larger in the Y direction in the battery module BM having the same size as the thickness of the heat transfer member 103 is reduced, it is possible to contribute to improvement of energy density of the battery module BM.

In the present embodiment, when the all-solid-state battery 1 is used for the battery module BM, the portion P1 closer to the folded portion 82a is in contact with the heat transfer member 103, so that the side surface 81a of the housing portion 81 is not in contact with the heat transfer member 103. Here, when the side surface 81a of the housing portion 81 comes into contact with the heat transfer member 103, the side surface 81a also expands and contracts following the expansion and contraction of the laminate 2. Therefore, in a case where the gel-like heat transfer member 103 is bonded to the side surface 81a in consideration of the heat transfer property, it is necessary to secure the thickness of the heat transfer member 103 such that the gel-like heat transfer member 103 extends in accordance with the expansion of the side surface 81a. However, in the present embodiment, since the portion P1 closer to the folded portion 82a that does not follow the expansion and contraction of the laminate 2 comes into contact with the heat transfer member 103, it is not necessary to consider the extension of the gel-like heat transfer member 103. Also from this viewpoint, in the present embodiment, the heat transfer member 103 can be thinned in the Y direction.

### Modifications

FIGS. 6A to 6C are diagrams illustrating modifications of the exterior body 8 of the above embodiment. Hereinafter, description of configurations similar to those of the above embodiment will be omitted.

An exterior body 608 of FIG. 6A is different from the exterior body 8 of the above embodiment mainly in that a portion P61 closer to a folded portion 682a does not include the region R3. That is, the portion P61 closer to the folded portion 682a is folded at two portions of the connection portion 82e with the housing portion 81 and the boundary between the region R1 and the region R2. Even with such a configuration, it is possible to suppress the irregularities of the contact surface of the all-solid-state battery 1 with the heat transfer member 103.

An exterior body 708 of FIG. 6B is different from the exterior body 8 of the above embodiment mainly in that a portion P71 closer to a folded portion 782a is provided so as to have a width larger than the width of the laminate 2 in the Z direction. According to this modification, since the area of the flat contact surface between the all-solid-state battery 1 and the heat transfer member 103 can be further increased, the heat transfer property is further improved. As described above, a part of the portion P71 closer to the folded portion 782a may be folded along the side surface 81a, and the remaining portion may be provided at a position not along the side surface 81a, or the entire portion P1 may be folded along the side surface 81a as in the above embodiment.

An exterior body 808 of FIG. 6C is different from the exterior body 8 of the above embodiment mainly in that a connection portion 882e between a housing portion 881 and a portion P81 closer to a folded portion 882a is provided at an end portion of the housing portion 881 in the Z direction. In a laminate film forming the exterior body 808, in a case where only one recess portion forming the housing portion 881 is provided, when the exterior body 808 is formed by folding the recess portion, the connection portion 882e is provided at the end portion in the Z direction. In such a case, by forming the region R1 of the portion P81 from the end portion where the connection portion 882e are provided to the other end portion in the Z direction, the irregularities of the contact surface of the all-solid-state battery 1 with the heat transfer member 103 can be suppressed. That is, the position in the Z direction of the connection portion 882e between the housing portion 881 of the exterior body 808 and the portion P81 closer to the folded portion 882a can be appropriately changed.

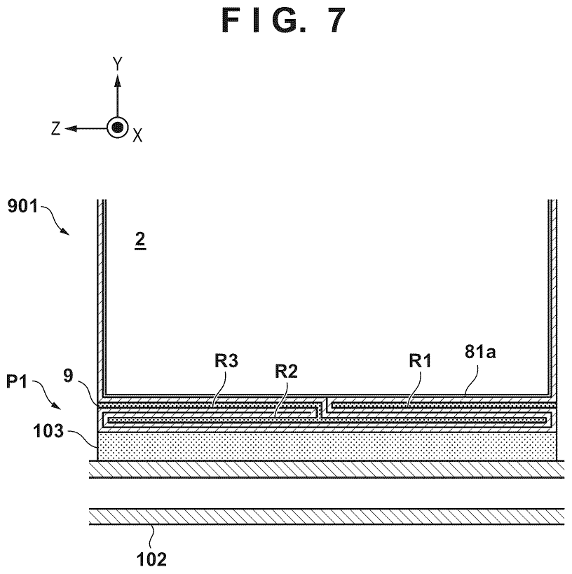

FIG. 7 is a diagram illustrating a modification of the lower structure of the all-solid-state battery. An all-solid-state battery 901 of this modification is different from the all-solid-state battery 1 of the above embodiment in that a grease 9 that is a highly viscous fluid is applied to the portion P1 closer to the folded portion 82a. For example, in the all-solid-state battery 901, the portion P1 is folded in a state where the grease 9 is applied to the portion P1 before the portion P1 closer to the folded portion 82a is folded (see FIG. 5). Alternatively, the grease 9 may be applied to the portion P1 in a state where the portion P1 closer to the folded portion 82a is folded. Here, the grease 9 exists between the side surface 81a of the exterior body 8 and the regions R1 and R3 and between the regions R1 and R3 and the region R2. However, the arrangement of the grease 9 can be changed as appropriate. For example, in FIG. 7, since it is difficult to form an air layer between the region R2 and the heat transfer member 103, a grease is not provided therebetween, but the grease 9 may be applied therebetween.

Here, in the all-solid-state battery 1 of the above embodiment, the folded laminates of the portion P1 closer to the folded portion 82a (for example, the region R1 and the region R2) are in contact with each other, but strictly speaking, an air layer exists therebetween. This air layer may hinder heat transfer from the all-solid-state battery 1 to the heat transfer member 103.

On the other hand, in the present modification, the grease 9 exists in the gap of the folded portion P1, so that it is possible to suppress air from entering between the folded laminates, and the adhesion between the laminates is improved. Therefore, heat can be more effectively transferred from the all-solid-state battery 1 to the heat transfer member 103. Furthermore, by adopting the grease 9, it is possible to follow the expansion of the laminate 2, and the thickness can be further reduced, so that the heat transfer property is further improved.

As a base oil component of the grease which is the highly viscous fluid, mineral oil, silicone, or the like can be adopted. In addition, when the grease is adopted as the highly viscous fluid, from the viewpoint of reducing pump-out, for example, a grease having an ASTM (JIS) consistency of 1 to 6 can be used.

In the description of the above embodiment, the all-solid-state battery 1 having the laminate 2 including the solid electrolyte layer 27 is exemplified as a power generation element, but the features of the above embodiment can also be applied to other storage batteries in which the power generation element is packed with a laminate material. For example, the features of the above embodiment can also be applied to a storage battery or the like such as a lithium ion battery containing an electrolytic solution or a gel electrolyte as an electrolyte.

### Summary of Embodiments

The above embodiment discloses at least the following storage battery, battery module, and laminate film.

1. According to the above embodiment, a storage battery (1) includes:
a power generation element (2); and
an exterior body (8) configured to wrap the power generation element, in which
the exterior body is formed by folding a member (301) forming the exterior body in two at a folded portion (82a, 320),
the exterior body includes
   a housing portion (81) housing the power generation element, and
   a peripheral edge portion (82) around the housing portion including the folded portion, and
a first portion (P1) of the peripheral edge portion closer to the folded portion than a side surface (81a) of the housing portion adjacent to the folded portion is folded along the side surface.

According to this embodiment, since the portion of the peripheral edge portion closer to the folded portion than the side surface of the housing portion adjacent to the folded portion is folded along the side surface, the exterior body is easily flattened at the folded portion. For this reason, when this portion comes into contact with the heat transfer member, the contact area can be further increased. Therefore, the heat of the storage battery can be efficiently transferred to the cooling/heating element.

2. According to the above embodiment,
the first portion includes
   a first region (R1) extending from a connection portion with the housing portion to one side in a thickness direction of the power generation element, and
   a second region (R2) extending from an end portion on the one side of the first region to the other side opposite to the one side.

According to this embodiment, the portion closer to the folded portion is folded to form the plurality of regions, so that irregularities of a contact surface between the storage battery and the heat transfer member are easily reduced. Therefore, a gap or the like is less likely to be generated between the storage battery and the heat transfer member, and the storage battery and the heat transfer member are more likely to be in close contact with each other, so that the heat of the storage battery can be efficiently transferred to the cooling/heating element.

3. According to the above embodiment,
the first portion includes a third region (R3) extending to the one side from an end portion on the other side of the second region to the folded portion.

According to this embodiment, the height of the portion closer to the folded portion is stabilized, and the irregularities of the contact surface between the storage battery and the heat transfer member can be further reduced.

4. According to the above embodiment,
the first region and the third region are located closer to the power generation element than the second region.

According to this embodiment, since the portion closer to the folded portion and the heat transfer member are in contact with each other only in the second region, a step or the like is hardly formed on the contact surface. Therefore, the irregularities of the contact surface between the storage battery and the heat transfer member can be further reduced.

5. According to the above embodiment,
the second region extends from a position of an end portion on the one side of the power generation element to a position of an end portion on the other side in the thickness direction.

According to this embodiment, since the second region is provided to extend over substantially the entire thickness direction below the laminate, the contact surface with the heat transfer member in the storage battery can be configured by the second region. Therefore, the irregularities of the contact surface between the storage battery and the heat transfer member can be further reduced.

6. According to the above embodiment,
a length (L1) from the side surface to the folded portion is substantially twice a length in a thickness direction of the power generation element.

According to this embodiment, the total length of the first region and the third region and the total length of the second region are substantially the same in the thickness direction of the laminate. Therefore, the irregularities of the contact surface between the storage battery and the heat transfer member can be further reduced.

7. According to the above embodiment,
a length (L1) from the side surface to the folded portion is equal to or more than a length from a connection portion of the first portion with the housing portion to any end portion of the housing portion in a thickness direction of the power generation element.

According to this embodiment, since the portion close r to the folded portion can be extended to at least the end portion in the thickness direction of the housing portion, it is possible to suppress the occurrence of a step due to a break at a position where the portion closer to the folded portion overlaps the adjacent side surface in the thickness direction.

8. According to the above embodiment,
the first portion is folded in a state where a highly viscous fluid is applied.

According to this embodiment, it is possible to suppress formation of an air layer between the members when the portion closer to the folded portion is folded, and it is possible to suppress a decrease in the heat transfer property.

9. According to the above embodiment,
the power generation element is a laminate (2) in which a positive electrode layer (21A, 21B), a solid electrolyte layer (27), and a negative electrode layer (24A, 24B) are stacked.

According to this embodiment, the heat of the storage battery can be efficiently transferred to the cooling/heating element.

10. According to the above embodiment,
a battery module (BM) includes:
the storage battery of any one of the above 1 to 8; and
a heat transfer member (103) disposed to be in contact with the first portion of the storage battery.

According to this embodiment, a cooling/heating battery module capable of more efficiently releasing the heat of the storage battery from the heat transfer member is provided.

11. According to the above embodiment,
the battery module further includes a cooling/heating unit (102) configured to cool or heat the storage battery,
the heat transfer member is disposed between the storage battery and the cooling/heating unit.

12. According to the above embodiment, a laminate film (301) forms an exterior body (8) by wrapping a power generation element (2),
the exterior body is formed by folding the laminate film in two at a folded portion,
the exterior body includes
   a housing portion (81) housing the power generation element, and
   a peripheral edge portion (82) around the housing portion,
the laminate film includes
   a first recess portion (311) provided on one side (310) with respect to the folded portion and forming the housing portion, and
   a second recess portion (321) provided at a position corresponding to the first recess portion on the other side (320) opposite to the one side with respect to the folded portion and forming the housing portion, and
a distance (L2) between the first recess portion and the second recess portion is equal to or more than a sum of depths (d1, d2) of the first recess portion and the second recess portion.

According to this embodiment, it is possible to form an exterior body in which the irregularities of the contact portion with the heat transfer member are suppressed when the exterior body is used in the battery module.

The invention is not limited to the foregoing embodiments, and various variations/changes are possible within the spirit of the invention.

What is claimed is:

1. A storage battery comprising:
a power generation element; and
an exterior body configured to wrap the power generation element, wherein
the exterior body is formed by folding a member forming the exterior body in two at a folded portion,
the exterior body includes
a housing portion housing the power generation element, and
a peripheral edge portion around the housing portion including the folded portion, and
a first portion of the peripheral edge portion closer to the folded portion than a side surface of the housing portion adjacent to the folded portion is folded along the side surface.

2. The storage battery according to claim 1, wherein
the first portion includes
a first region extending from a connection portion with the housing portion to one side in a thickness direction of the power generation element, and
a second region extending from an end portion on the one side of the first region to the other side opposite to the one side.

3. The storage battery according to claim 2, wherein
the first portion includes a third region extending to the one side from an end portion on the other side of the second region to the folded portion.

4. The storage battery according to claim 3, wherein
the first region and the third region are located closer to the power generation element than the second region.

5. The storage battery according to claim 2, wherein
the second region extends from a position of an end portion on the one side of the power generation element to a position of an end portion on the other side in the thickness direction.

6. The storage battery according to claim 1, wherein
a length from the side surface to the folded portion is substantially twice a length in a thickness direction of the power generation element.

7. The storage battery according to claim 1, wherein
a length from the side surface to the folded portion is equal to or more than a length from a connection portion of the first portion with the housing portion to any end portion of the housing portion in a thickness direction of the power generation element.

8. The storage battery according to claim 1, wherein
the first portion is folded in a state where a highly viscous fluid is applied.

9. The storage battery according to claim 1, wherein
the power generation element is a laminate in which a positive electrode layer, a solid electrolyte layer, and a negative electrode layer are stacked.

10. A battery module comprising:
the storage battery according to claim 1; and
a heat transfer member disposed to be in contact with the first portion of the storage battery.

11. The battery module according to claim 10, further comprising:
a cooling/heating unit configured to cool or heat the storage battery, wherein
the heat transfer member is disposed between the storage battery and the cooling/heating unit.

12. A laminate film that forms an exterior body by wrapping a power generation element, wherein
the exterior body is formed by folding the laminate film in two at a folded portion,
the exterior body includes
a housing portion housing the power generation element, and
a peripheral edge portion around the housing portion,
the laminate film includes
a first recess portion provided on one side with respect to the folded portion and forming the housing portion, and
a second recess portion provided at a position corresponding to the first recess portion on the other side opposite to the one side with respect to the folded portion and forming the housing portion, and
a distance between the first recess portion and the second recess portion is equal to or more than a sum of depths of the first recess portion and the second recess portion.
